(19) United States
(12) Patent Application Publication
(10) Pub. No.: US 2015/0365754 A1
(43) Pub. Date: Dec. 17, 2015

(54) MOTOR VEHICLE AND MICROPHONE FOR A MICROPHONE ARRANGEMENT IN THE MOTOR VEHICLE

(71) Applicant: AUDI AG, Ingolstadt (DE)

(72) Inventor: MARTIN PERL, Ingolstadt (DE)

(73) Assignee: Audi AG, 85045 Ingolstadt (DE)

(21) Appl. No.: 14/763,457

(22) PCT Filed: Jan. 22, 2014
(86) PCT No.: PCT/EP2014/000161

§ 371 Date: Jul. 24, 2015

(30) Foreign Application Priority Data
Jan. 26, 2013 (DE) 10 2013 001 385.2

(51) Int. Cl. H04R 1/08

(52) U.S. Cl. CPC H04R 1/08; H04R 2499/13; H04R 2201/003

(57) ABSTRACT

A microphone for sound detection in a motor vehicle includes a microphone capsule with a sound inlet opening, a microphone diaphragm arranged in the microphone capsule and a driver circuit arranged in the microphone capsule for generating an individual electrical diaphragm signal depending on a movement of the microphone diaphragm. Connection contacts, which are arranged such that they can be reached from outside the microphone capsule and are connected to the microphone capsule, supply an electrical microphone signal. This microphone arrangement for sound detection in a motor vehicle requires little installation space. To this end, an interface circuit is likewise arranged in the microphone capsule and is designed to convert the individual diaphragm signal of the driver circuit directly into a digital bus signal according to a predefined bus standard and to output the bus signal as the microphone signal via the connection contacts to a data bus.

The invention relates to a microphone for sound detection in a motor vehicle. The microphone has a microphone capsule, in which a microphone diaphragm and a driver circuit for generating an electrical signal from a diaphragm movement are integrated. From the microphone, an electrical microphone signal can be tapped via connection contacts. The present invention also includes a motor vehicle, in which a microphone arrangement is provided, as is made possible with several of the microphones according to the invention.

In order to be able to detect sound signals in a motor vehicle, in particular speech, with the lowest possible noise, i.e. with high quality, a plurality of microphones may be arranged in the vehicle interior. A directional cylinder microphone for installation in a motor vehicle is known from DE 20 2009 010 884 U1, wherein a microphone capsule, an amplifier circuit and a cable holder for affixing a connecting cable are arranged in a microphone housing. The connecting cable exits the microphone housing to allow tapping the signal from the microphone capsule. When several of these cylinders microphones are arranged in a motor vehicle, a separate cable must disadvantageously be arranged from each cylinder microphone cable for analysis by the central processing unit, also referred to as a head-unit. This results in a wiring arrangement prone to interference and overall in poor scalability of the microphone arrangement, because the diameter of the resulting wiring harness on the head unit increases with the number of microphones arranged in the interior space of the motor vehicle.

EP 1 053 912 A2 discloses a directional microphone that is built into a dashboard of a motor vehicle. To this end, a microphone capsule is soldered onto a printed circuit board of the instrument panel. In order to obtain a directional effect, the circuit board or other structural elements of the dashboard may have an arrangement of through-openings for a directional detection of sound. Due to the arrangement of the microphone capsule on the printed circuit board, no separate wiring is required. Instead, the microphone capsule can be connected by way of conductive paths disposed on the circuit board via a bus system with a speech processing system that is positioned at a suitable point of the motor vehicle independent of the microphone capsule. This solution has the disadvantage that microphone capsules can be provided only where a circuit board is present, on which appropriate interface circuits for the bus system are soldered. Thus, a microphone capsule cannot be accommodated, for example, in the roof lining of the motor vehicle because printed circuit board are not present at this location.

DE 10 2010 034 237 A1 discloses a similar microphone system for a motor vehicle with a plurality of microphone devices distributed in the motor vehicle. The microphone devices are connected to the head-unit of the motor vehicle via a bus system. Each of the microphone devices includes a respective microphone cluster with three individual microphone capsules. The PDM signals (PDM—pulse density modulation) of the microphone capsules are converted in a signal converter to PCM signals (PCM—pulse code modulation). Each of the microphone devices has a bus controller for the bus communication. The bus system is a synchronous MOST bus system having two optical conductors arranged in the ring structure. The signals from the microphone capsule of the microphone cluster of each microphone device should be combinable into a beamforming signal. In order to exactly match the timing of the signals from the microphone capsules of the respective microphone cluster for the individual microphone devices time to one another, beamforming requires that the circuit components of a microphone cluster are supplied with a common clock signal. The microphone signals of the individual microphones of a microphone cluster must also be combined by a common bus controller and sent together to the head unit. For this reason, the individual microphone devices composed of the microphone cluster, the converter device from PDM to PCM, and the bus controller are still relatively large.

It is the object of the invention to provide a microphone arrangement for sound detection in a motor vehicle that requires little installation space.

The object is attained with a microphone according to claim 1 and a motor vehicle according to claim 13. Advantageous embodiments of the invention are recited in the dependent claims.

In the microphone according to the invention, a microphone diaphragm is arranged in a microphone capsule in conventional manner. The microphone capsule has at least one sound inlet opening, through which an airborne sound from outside the microphone capsule can pass to the microphone diaphragm and can cause the microphone diaphragm to move. Furthermore, a driver circuit is disposed in the microphone capsule. Driver circuit herein refers to an electronic circuit that generates an electric diaphragm signal in response to the movement of the microphone diaphragm in a known manner. It is important for an understanding of the invention that this is a single signal that describes the movement of the microphone diaphragm and represents the audio signal contained in the sound. A combination of several electrical signals into a beamforming signal is not contemplated. Externally accessible connection contacts are arranged on the microphone capsule, through which the microphone can supply an electrical microphone signal. However, this microphone signal does not correspond directly to the electrical signal of the driver circuit. Instead, an additional circuit is connected in the microphone according to the invention between the driver circuit and the connection contacts, which will be referred to herein as an interface circuit. This interface circuit is also arranged in the microphone capsule and is configured to convert the single diaphragm signal of the driver circuit into a digital signal bus in accordance with a predetermined bus standard. This bus signal is then outputted as the microphone signal via the connection contacts. When an acoustic sound is detected by the microphone diaphragm, a bus signal which can be outputted to a data bus is immediately generated therefrom by the microphone according to the invention. The microphone can hence be operated directly as a bus node of a data bus when the connection contacts of the microphone capsule are connected to the bus.

The microphone according to the invention has the advantage that now a single component, namely the microphone capsule, is provided which can be connected directly to a data bus and which can feed an audio signal directly to the data bus.

A further advantage is obtained by designing the interface circuit for insertion of the microphone signal into a time-division-multiplex signal of the data bus. A plurality of the microphones according to the invention may then be arranged along a bus line of the data bus and the microphone signals of all microphones can be transmitted as a time-division-multiplex signal on the same bus line to a central processing device, for example a head-unit or an infotainment system. This advantageously reduces the wiring complexity for such a microphone arrangement.

Preferably, the interface circuit of the microphone according to the invention is also configured to communicate bidirectionally via the data bus and to thereby receive a diagnostic query and to generate a diagnostic message for the diagnostic inquiry in response to an operational capability of a component of the microphone. Advantageously, a self-check of the microphone may be initiated via the data bus, with which, for example, the microphone diaphragm, the driver circuit and the interface circuit can be checked for proper operation. This can be performed automatically by a control device, for example each time the motor vehicle is started, with a recommendation for the driver to visit to a repair facility if a defect is detected.

In order to advantageously reduce the wiring complexity even further, only two output pins may preferably be provided as connection contacts for outputting the microphone signal. The microphone can then be connected, for example, via a twisted-pair cable to a central processing facility. An output pin may be formed, for example, by a wire.

Another advantage is obtained if, in addition to the connection contacts for outputting the microphone signal, input contacts for receiving a bus signal from another microphone are arranged on the microphone capsule. The other microphone is hereby preferably also an embodiment of the microphone according to the invention. The bus signal of the other microphone is then also received via the input contacts. The interface device must then be designed to loop this received bus signal through to the aforementioned connection contacts for outputting the own microphone signal. This embodiment represents a specific variant of the aforedescribed possibility for collectively transmitting the microphone signals of multiple microphones to a central processing unit via a common bus line.

According to a particularly preferred embodiment, the interface circuit may be designed to generate the bus signal in accordance with the A2B bus standard. With this bus standard, a time-division-multiplex signal having a sufficiently high bandwidth for the transmission of multiple microphone signals can be transmitted over an unshielded twisted-pair bus line. In other words, all the aforedescribed advantages can be realized by using an A2B interface circuit.

Another advantage arises when the microphone diaphragm is provided by a micro-electro-mechanical system or MEMS for short. Another term for such a system is silicon microphone. In this way, the microphone diaphragm, the driver circuit and the interface circuit can be arranged on a common printed circuit board. This results in a particularly compact design of the microphone.

The driver circuit and the interface circuit are preferably phantom-fed via the connection contacts, enabling the microphone to be supplied with electrical power via the bus lines. This further reduces the number of lines.

The driver circuit may include an amplifier circuit and a converter circuit connected downstream of the amplifier circuit. In this case, the amplifier circuit generates an electrical analog signal in response to the movement of the microphone diaphragm, with the converter circuit then generating a digital signal from the analog signal. The digital signal is in particular one of the following: an I2S signal (I2S—Inter-IC sound interface, IC—Integrated Circuit), a PDM signal or a PCM signal. This embodiment of the microphone has the advantage that the driver circuit generates a digital audio stream which can thereafter be transmitted to another integrated circuit disposed inside the microphone capsule and representing the interface circuit, i.e. for example an A2B bus controller. This embodiment has the advantage that standard components may be used for implementing, on the one hand, the driver circuit and, on the other hand, the interface circuit. Another (not specifically claimed) embodiment of the microphone according to the invention contemplates to realize the driver circuit and the interface circuit in form of a common integrated circuit (IC). A single IC in the microphone capsule is then sufficient.

In an advantageous embodiment, the microphone capsule may include a metal cup in which at least the microphone diaphragm and the driver circuit are located. Preferably, the interface circuit is also arranged in the metal cup. Advantageously, the metal is aluminum. Provision of a metal cup shields the driver circuit and the interface circuit from interfering electromagnetic radiation. Aluminum can be suitably shaped by pressing.

According to another embodiment of the microphone according to the invention, the interface circuit is designed to receive an external clock signal and to provide the clock signal to the driver circuit. In this way, the driver circuits of several microphones can advantageously be synchronized, even though they are located in separate microphone capsules and connected to a data bus with separate interface circuits. The clock signal may be a bus clock of the data bus. This obviates the need for an additional clock.

As already discussed, the invention is also directed to a motor vehicle, preferable to a passenger car. The motor vehicle according to the invention includes a microphone arrangement composed of a plurality of microphones, each of which represents an embodiment of the microphone according to the invention. All microphones are connected via a common bus with a central receiving unit. The microphones each generate a bus signal with respect to a corresponding locally detected sound and combine their bus signals on the bus line to a time-division-multiplex signal that can be received by the central receiving unit. The infotainment system can then receive and process a microphone signal as an audio input signal.

The vehicle of the invention has the advantage that a plurality of individual microphones can be distributed in an interior space of the motor vehicle, for example in a headliner, wherein very little installation space needs to be provided for each of the microphones. The bus line can also be very simple, especially have a small diameter, since all microphones use the bus together. The microphone arrangement is therefore also readily scalable since it is not necessary to construct a complete line from the additional microphones to the receiving unit just for providing an additional microphone.

The particular microphone signal with the best audio quality from all the microphone signals can then be transmitted from the receiving unit to an infotainment system. According to a preferred embodiment of the motor vehicle, the receiving unit forms a selection circuit. For this purpose, the receiving unit is designed to extract from the bus signals of all microphones the particular microphone signal (i.e. to reassemble the individual data packets received via the data bus) and to determine for each extracted microphone signal a value for a quality measure. The extracted microphone signal with the largest value of the quality measure is then passed on to the infotainment system as the actual audio input signal. This advantageously ensures that always the microphone signal having the best audio quality is provided to the infotainment system. For example, a signal-to-noise ratio may be estimated as the quality measure. Estimation algorithms for this purpose are known in the prior art. For example, a resting level may be determined by long-time averaging of the respective microphone signal, whereafter a ratio of the actual level to the resting level is calculated when a level in the microphone signal changes. Of course, there is also the individual access to each microphone signal, so that a combination from a plurality of microphone signals can also be formed, for example a beamforming signal.

Moreover, the audio input signal may be transmitted within the infotainment system to a telephony module of the infotainment system and/or to a speech recognition module of the infotainment system. These modules operate then particularly reliably with audio input signal having the high audio quality.

The invention will now be explained once more with reference to specific exemplary embodiments, wherein:

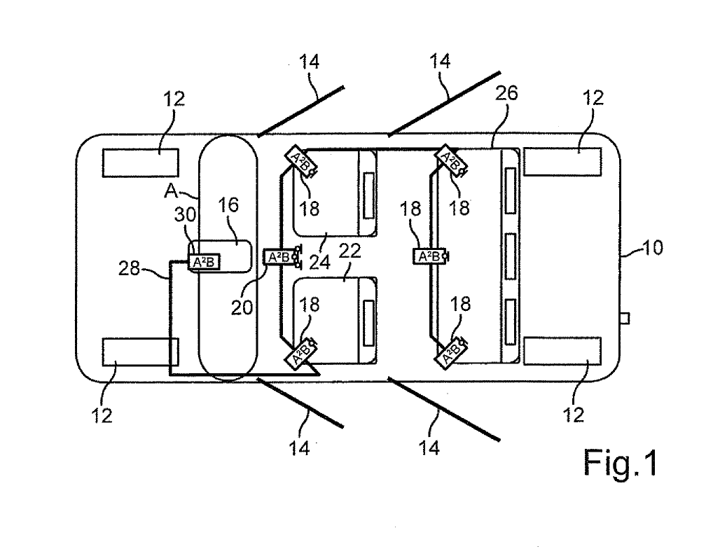

FIG. 1 shows a schematic diagram of a preferred embodiment of the motor vehicle according to the invention,

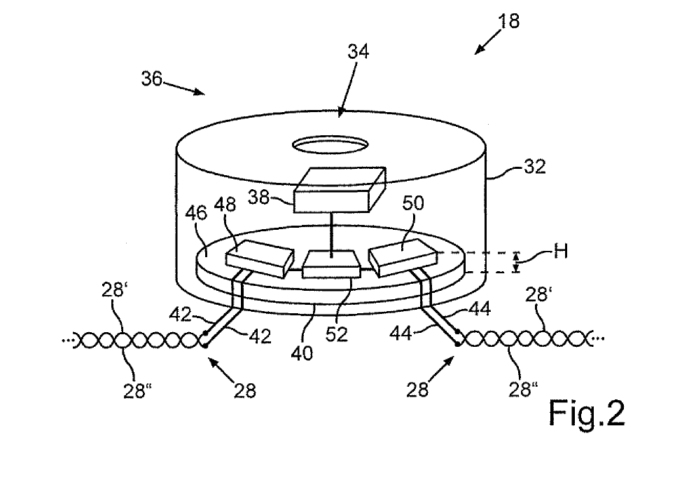

FIG. 2 shows a schematic diagram of an embodiment of the microphone according to the invention that can be installed in the motor vehicle of FIG. 1, and

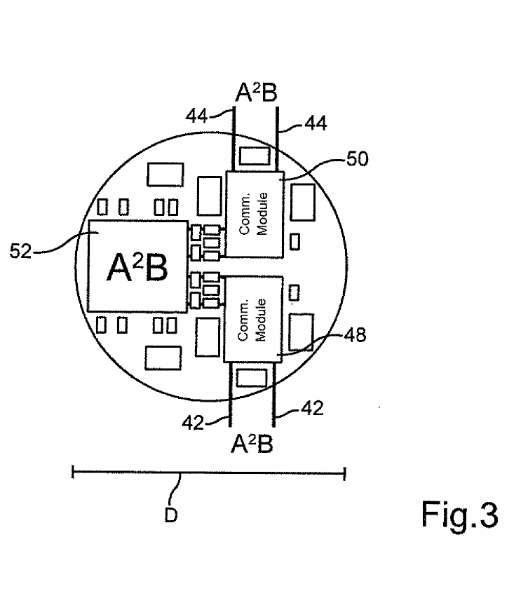

FIG. 3 shows a block diagram of an interface circuit of a type that can be installed in the microphone of FIG. 2.

The examples illustrate the preferred embodiment of the invention.

FIG. 1 shows in a plan view a motor vehicle 10, which may be, for example, a passenger car. For better visual guidance, the position of wheels 12 and of motor vehicle doors 14 is indicated. The motor vehicle 10 has a head unit 16 that is located in a front part, for example in a center console or underneath an instrument panel A, for providing, for example, an infotainment system. The head unit 16 may include, for example, a telephony module, such as a UMTS module or LTE module. The head unit 16 may also include a speech recognition module which may for example be provided as a program module. In order to detect a voice signal of an occupant of the motor vehicle 10 for telephony or voice recognition, microphones 18, 20 may be arranged, for example, in a headliner of the motor vehicle 10. The microphones 18, 20 may be arranged, for example, above a driver seat 22, a front seat 24 and a back seat 26. The microphones 18 may each be constructed in accordance with an embodiment of the microphone according to the invention. The microphone 20 includes a plurality of microphone capsules, which are connected to one another via a common printed circuit board. The exact structure of the microphone 20 is not essential for an understanding of the invention and will therefore not be further elaborated on.

The microphones 18 are relatively small and can thus be easily integrated into the headliner. The microphones 18 generate digital output signals, with a common, single bus line 28 connecting the microphones 18, 20 with a receiving unit 30 of the head unit 16. The bus line 28 may be, for example, an unshielded twisted-pair cable. The receiver unit 30 may, for example, be a commercially available A2B receiving circuit.

Each of the microphones 18, 20 can transmit as a bus signal over the bus line 28 a respective digital microphone signal in a time-division-multiplexing process in respective assigned time slots to the receiving unit 30 in sections. The microphones 18 have for this purpose their own interface circuit which enables the insertion of the respective own digital microphone signal in the time-division-multiplex signal. Conversely, the microphones 20 require an external interface circuit, since the microphone signals of several microphone capsules must be combined before they can be transmitted. This makes the microphone 20 is relatively large.

The structure of the individual microphones 18 will now be explained in more detail with reference to FIG. 2 and FIG. 3.

FIG. 2 shows for this purpose a single microphone 18. The microphone 18 can include a microphone capsule 32 made for example of aluminum. The microphone capsule 32 has a sound inlet opening 34. The microphone capsule 32 can also have several sound entry openings. Sound can pass through the sound inlet opening 34 from an environment 36 of an (unillustrated) microphone diaphragm inside the microphone capsule 32. A driver circuit 38 generates an electrical signal upon movement of the microphone diaphragm in a conventional manner. The driver circuit 38 can also include a digitizing circuit, with which the analog signal of the diaphragm movement can be converted into a digital audio signal, for example an I2S signal, PDM signal or the PCM signal. Conventional technologies can be employed for realizing a corresponding conversion circuit.

The driver circuit 38 transmits the digital signal representing the sound signal to an interface circuit 40, which couples the driver circuit 38 with connection contacts 42 of the microphone 18, via which the microphone 18 is electrically connected to the portion of the bus line 28 leading to the receiving unit 30. Additional connection contacts 44 of the microphone 18 are electrically connected to the portion of the bus line 28 that leads to additional microphones 18, The connection contacts 42, 44 may, for example, be pins formed from wires. Wires 28′, 28″ of the bus line 28 are illustrated for sake of clarity of the illustration.

The interface circuit 40 may include a circuit board or a printed circuit board 46, on which a communication module 48 for the transmission of data to the receiving unit 30 and a communication module 50 for receiving data via the connections 44 may be arranged. The diameter D of the circular printed circuit board 46 may, for example, be 15 mm. The height H, which is composed of the thickness of the printed circuit board 16, 46 and the height of the modules 48, 50, 52 arranged thereon, may for example be 4 to 5 mm. The mounted components 48, 50, 52 may, for example, have a height of up to 3 mm. Retaining elements for the interface circuit 40 and the driver circuit 38 are omitted in FIG. 2.

The communication modules 48, 50 can be coupled via a bus driver 52. The driver circuit 38 can also be coupled to the bus driver 52. The bus driver 52 may, for example, be an A2B module.

An exemplary arrangement of the communication modules 48, 50 and of the bus driver 52 is shown in FIG. 3. Additional components that are not relevant for describing the invention are also shown with their position and size in relation to the aforementioned modules. The communication modules 48, 50 can loop data through the microphone 18 via the bus driver 52 so that data can also be forwarded to the receiving unit 30 for other microphones that send data via the connection contacts 44 to the interface circuit 40, by looping these data through. In the reverse direction, diagnostic queries of the receiving unit 30 can also be looped through.

The bus driver 52 can additionally insert data from the driver circuit 38 into the data stream, for example, based on a time-division-multiplex method. Particularly suited for transmission of the digitized audio data of all microphones with the cascaded circuit (daisy chain) of the microphones 18 and the microphone 20 at a sufficiently high sampling rate (for example, 8 kHz or 16 kHz) to the receiving unit 30 is the bus standard A2B, In the receiving unit 30, those signals of the microphones 18, 20 that satisfy a predetermined quality criterion, for example represent the loudest signal or have the highest value for the SNR (signal-to-noise-ratio), can then be transmitted, for example, to the telephony module or the speech recognition module of the infotainment system 16.

This example demonstrates how a complete integration of a bus interface can be implemented directly in the capsule of a microphone. The microphone capsule is connected via the interface to a vehicle bus, in particular to an A2B bus. This provides more flexibility in the arrangement and wiring of the microphones in the vehicle.

What is claimed is:

1.-15. (canceled)

16. A microphone (18) for detecting sound in a motor vehicle, comprising:
a microphone capsule comprising a metal cup and at least one sound inlet opening,
a microphone diaphragm disposed in the metal cup of the microphone capsule,
a driver circuit disposed in the metal cup of the microphone capsule, with the driver circuit generating in response to a movement of the microphone diaphragm a single electrical diaphragm signal representing an audio signal contained in the sound,
connection contacts arranged to be accessible from outside the microphone capsule and connected to the microphone capsule for supplying an electrical microphone signal, and
an interface circuit arranged in the metal cup of the microphone capsule and configured to convert the single diaphragm signal of the driver circuit to a digital bus signal according to a predetermined bus standard and to directly output the digital bus signal as the microphone signal via the connection contacts to a data bus,
wherein the microphone capsule provides a single component configured to be directly connected to the data bus.

17. The microphone of claim 16, wherein the interface circuit is configured to generate the bus signal by inserting the microphone signal into a time-division-multiplex signal of the data bus.

18. The microphone of claim 16, wherein the interface circuit is configured for bi-directional communication over the data bus by receiving a diagnostic query and generating a diagnostic message in dependence of an operability of a component of the microphone.

19. The microphone of claim 16, wherein the connection contacts comprise two output pins.

20. The microphone of claim 16, wherein the microphone capsule comprises, in addition to the connection contacts for supplying the electrical microphone signal, input contacts for receiving a bus signal of another identically constructed microphone, and wherein the interface circuit is configured to loop the received bus signal through to the connection contacts.

21. The microphone of claim 16, wherein the interface circuit is configured to generate the bus signal in accordance with the Automotive Audio Bus (A2B) bus standard.

22. The microphone of claim 16, wherein the microphone diaphragm is provided by a Micro Electro-Mechanical System (MEMS).

23. The microphone of claim 16, wherein the driver circuit and the interface circuit are phantom-powered via the connection contacts.

24. The microphone of claim 16, wherein the driver circuit comprises an amplifier circuit and a converter circuit arranged downstream of the amplifier circuit, wherein the amplifier circuit is configured to generate in response to the movement of the microphone diaphragm an electrical analog signal, and the converter circuit is configured to generate from the electrical analog signal an Inter-IC Sound (I2S) signal or a Pulse-Density-Modulation (PDM) signal or a Pulse-Code Modulation (PCM) signal.

25. The microphone of claim 16, wherein the interface circuit is configured to receive an external clock signal and to provide the external clock signal to the driver circuit.

26. A motor vehicle comprising
a microphone arrangement composed of a plurality of microphones, each microphone comprising
a microphone capsule having a metal cup and at least one sound inlet opening,
a microphone diaphragm disposed in the metal cup of the microphone capsule,
a driver circuit disposed in the metal cup of the microphone capsule, with the driver circuit generating in response to a movement of the microphone diaphragm a single electrical diaphragm signal representing an audio signal contained in the sound,
connection contacts arranged to be accessible from outside the microphone capsule and connected to the microphone capsule for supplying an electrical microphone signal,
an interface circuit arranged in the metal cup of the microphone capsule and configured to convert the single diaphragm signal of the driver circuit to a digital bus signal according to a predetermined bus standard and to directly output the digital bus signal as the microphone signal via the connection contacts to a data bus,
wherein the microphone capsule is constructed as a single component configured to be directly connected to the data bus,
the motor vehicle further comprising
a central receiving unit connected to all of the plurality of microphones via the data bus, wherein the microphones are configured to transmit their respective bus signals to the central receiving unit over the data bus as a time-division-multiplexed signal, and
an infotainment system coupled with the central receiving unit and configured to process an audio input signal, wherein the central receiving unit is configured to extract from all received respective bus signals the respective microphone signal and to determine for each extracted microphone signal a value for a quality measure, and to forward the extracted microphone signal having the greatest value for the quality measure to the infotainment system as the audio input signal.

27. The motor vehicle of claim 26, wherein the infotainment system comprises at least one of a telephony module and a voice recognition module that are coupled to the central receiving unit for receiving the audio input signal.
